(19) United States
(12) Patent Application Publication
(10) Pub. No.: US 2023/0232759 A1
(43) Pub. Date: Jul. 27, 2023

(54) SYSTEMS AND METHOD FOR AUTOMATIC GROW SYSTEM

(71) Applicant: Christopher Farragut WATSON, Superior, CO (US)

(72) Inventor: Christopher Farragut WATSON, Superior, CO (US)

(21) Appl. No.: 18/100,483

(22) Filed: Jan. 23, 2023

Related U.S. Application Data
(60) Provisional application No. 63/301,655, filed on Jan. 21, 2022.

(51) Int. Cl. A01G 31/02

(52) U.S. Cl. CPC A01G 31/02

(57) ABSTRACT

An automated feeding system for plants is disclosed. The automated feed system comprises one or more plant housings which contain plants. The plant housings are coupled to a fill line an air line. A first pump coupled to a reservoir containing feed solution may pump feed solution to the file line, which transports the feed solution to the plant housing. A second pump pumps air into the air line, which is coupled to air stones located within the plant housing and configured to increase the volumetric pressure within the plant housing. The automated feed system further comprises a controller which is communicatively coupled to, and controls, the first pump and the second pump.

### CROSS-REFERENCE TO RELATED APPLICATIONS

This application claims the benefit of priority to U.S. Provisional Patent Application Ser. No. 63/301,655, filed Jan. 21, 2022, entitled “Hydroponic/Aeroponic Grow System,” the entire contents and disclosure of which is hereby incorporated by reference in its entirety.

### FIELD OF THE INVENTION

The present invention relates to an automated system, and, more particularly to an automated system for a grow system.

### BACKGROUND

Hydroponics is the process of growing plants using a water-based nutrient solution rather than soil. Aeroponics is a subset of hydroponics in which plants are grown in an air or mist environment rather than soil. Each environment can effect plant metabolism. Hydroponics/aeroponics offers many benefits, including but not limited to, a higher yield per growing area, less water, continuous production, and the ability to grow food in a variety of regions and locations. As such, hydroponics/aeroponics is growing in popularity. However, hydroponics/aeroponics systems are very sophisticated and require constant monitoring, which is expensive and time consuming. Therefore, systems and methods which improve efficiency and lower costs associated with growing food using hydroponics is desirable. In addition, it would be desirable to combine hydroponics and aeroponics systems in a manner that focuses on metabolic functions. It would be further desirable to realize the benefits of hydroponics/aeroponics from metabolically focused hybridized aeroponic and hydroponic systems.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a perspective view of an automated grow system in accordance with the embodiments of the disclosed invention.

FIG. 2 is a top view of the automated grow system of FIG. 1.

FIG. 3 is a side view of the automated grow system of FIG. 1.

FIG. 4 is a front view of the automated grow system of FIG. 1.

FIG. 5 is a back view of the automated grow system of FIG. 1.

FIG. 6 is a flowchart illustrating an automated grow method in accordance with the embodiments of the disclosed invention.

FIG. 7 illustrates a simplified functional block diagram of a computer system in accordance with the embodiments of the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

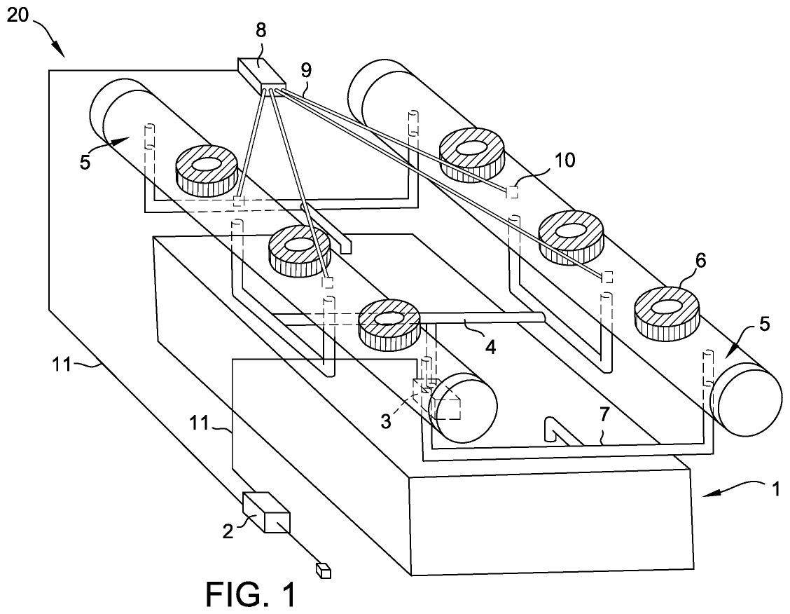

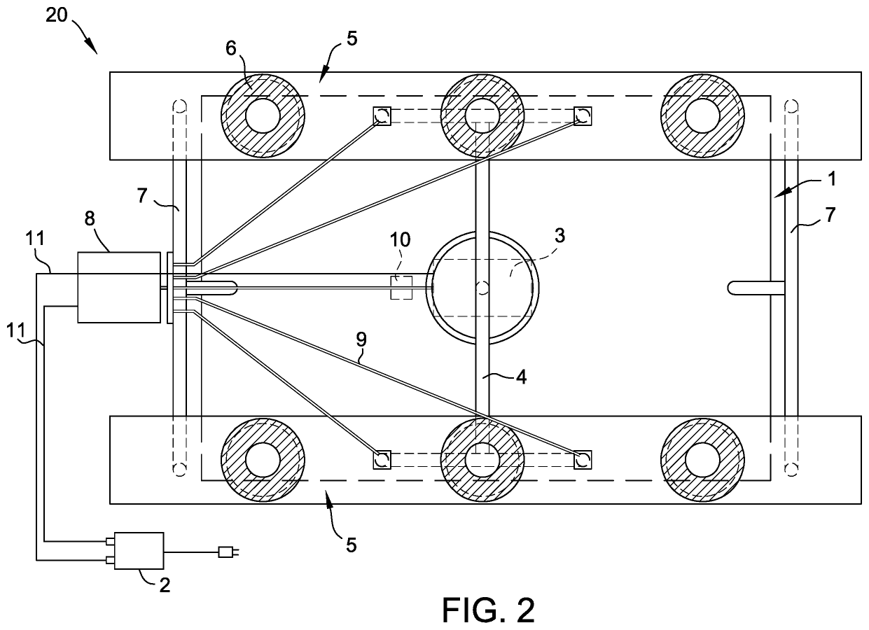

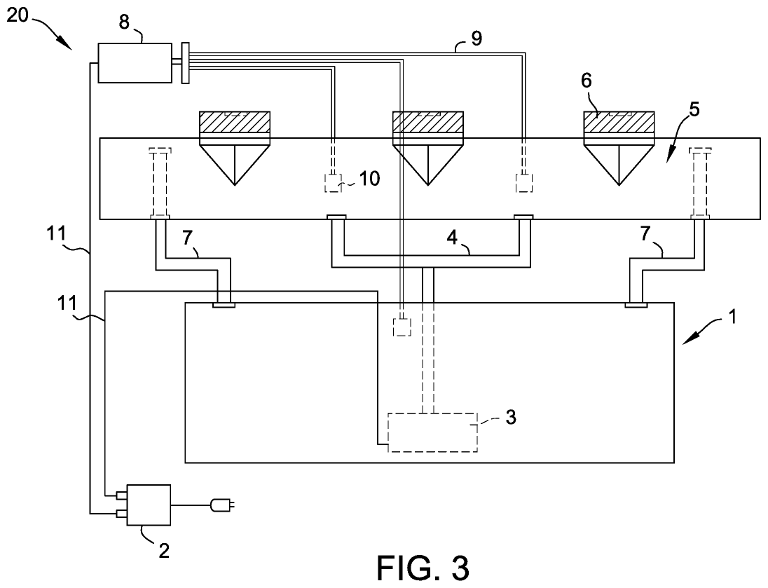

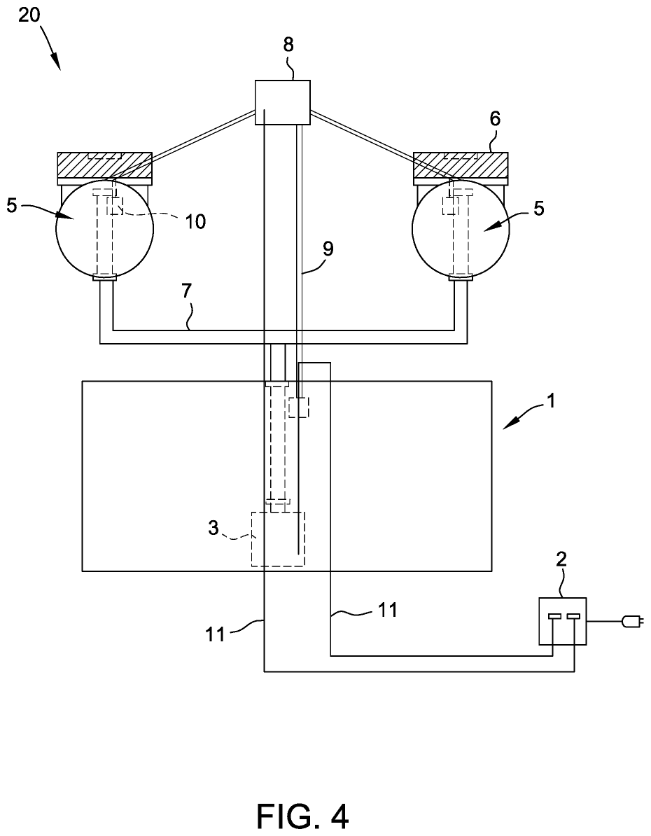

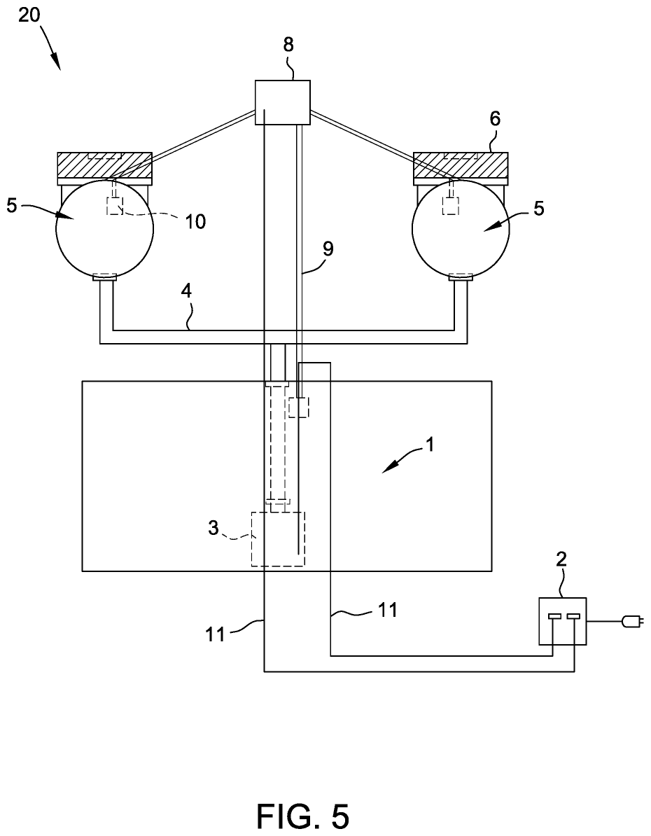

FIGS. 1-5 collectively represent the automated grow system 20 of the present disclosure. The automated grow system 20 manages the plant's metabolism through timed feedings that mimic an indulgence and fasting concept. The indulgence and fasting triggers hormonal responses within the plant, which leads to an increase in yield, quality, overall efficiency in cultivation, and has the potential to allow plants to express new genetic traits. The automated grow system of the present disclosure is energy efficient and reduces water use, thereby reducing waste with minimal footprint.

The automated grow system comprises a reservoir 1, a controller 2, a reservoir pump 3, a fill line 4, one or more plant housings 5, one or more plant housing caps 6, a drain line 7, an air pump 8, an air line 9, and one or more air stones 10.

Reservoir 1 is configured to be filled with the desired feed solution. Reservoir pump 3 and air pump 8 are communicatively coupled to controller 2. In some embodiments, reservoir pump 3 and air pump 8 are coupled to controller 2 via wired connections, for example, by cords 11. In other embodiments, reservoir pump 3 and air pump 8 are communicatively coupled to controller 2 via wireless connections, including but not limited to Wi-Fi, Bluetooth®, near-field communication (NFC), etc. Controller 2 is connected to a power source.

In response to controller 2 determining that it is time to feed the plants, controller causes reservoir pump 3 to go into an active state (i.e., start). In an active state, reservoir pump 3 pumps the feed solution into fill lines 4. In some embodiments, fill lines 4 are symmetrical. This enables reservoir pump 3 to pump feed solution into fill lines 4 at an even rate using symmetry in design. The determination by controller 2 that is time to feed the plants may be in response to a predetermined condition, such as a predetermined period of time passing or in response to data received by controller 2 from one or more sensors (not shown). For example, the determination that it is time to feed the plants may be in response to a predetermined period of time passing, the predetermined period of time being associated with indulgence and fasting mimicking.

Plant housings 5 are filled with the feed solution by fill lines 4 until the feed solution overflows into drain line 7. Drain line 7 recirculates the feed solution back to the reservoir 1, creating a constant current of turbulent feed solution within plant housings 5.

Air pump 8 feeds the air line 9, which feeds the air stones 10 located within the plant housing 5, ultimately diffusing air into the feed solution while it is recirculating. The added air, with plant housing caps 6, creates a seal around the base of the plant and the top of each plant housing 5 and increases the atmospheric pressure inside.

Once controller 2 determines the plants have had enough feed solution, controller 2 causes reservoir pump 3 and air pump 8 to go into an inactive state (i.e., stop). When reservoir pump 3 and air pump 8 are in an inactive state, plant housings 5 are drained completely of feed solution, leaving the roots completely exposed to air and allowing for greater atmospheric nitrogen fixation. The determination by controller 2 that the plants have received adequate feed solution may be in response to a predetermined condition, such as a predetermined period of time passing or in response to data received by controller 2 from one or more sensors (not shown). For example, the determination that the plants have received adequate feed solution may be in response to a predetermined period of time passing, the predetermined period of time being associated with indulgence and fasting mimicking.

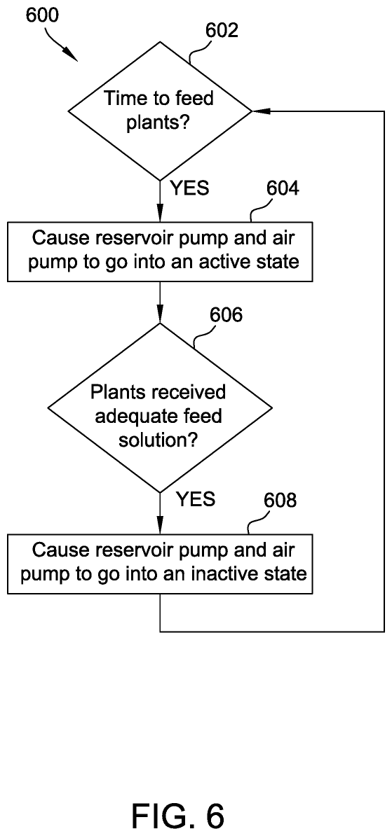

FIG. 6 is a flowchart of an example automated grow method of the present disclosure. FIG. 6 may be performed by one or more processor, such as controller 2 of automated grow system 20 of FIG. 1. At block 602, it is determined whether it is time to feed plants contained with the system. The determination that is time to feed the plants may be in response to a predetermined condition, such as a predetermined period of time passing or in response to data received by controller 2 from one or more sensors (not shown). For example, the determination that it is time to feed the plants may be in response to a predetermined period of time passing, the predetermined period of time being associated with indulgence and fasting mimicking.

At block 604, in response to a determination that it is time to feed the plants, the one or more processors cause a reservoir pump (e.g., reservoir pump 3) and an air pump (e.g., air pump 8) to go into an active state.

At block 606, it is determined whether the plants have received adequate feed solution. The determination that the plants have received adequate feed solution may be in response to a predetermined condition, such as a predetermined period of time passing or in response to data received by controller 2 from one or more sensors (not shown). For example, the determination that the plants have received adequate feed solution may be in response to a predetermined period of time passing, the predetermined period of time being associated with indulgence and fasting mimicking.

At block 608, in response to a determine that the plants have received adequate feed solution, the one or more processors cause the reservoir pump and the air pump to go into an inactive state. The method then returns to block 602.

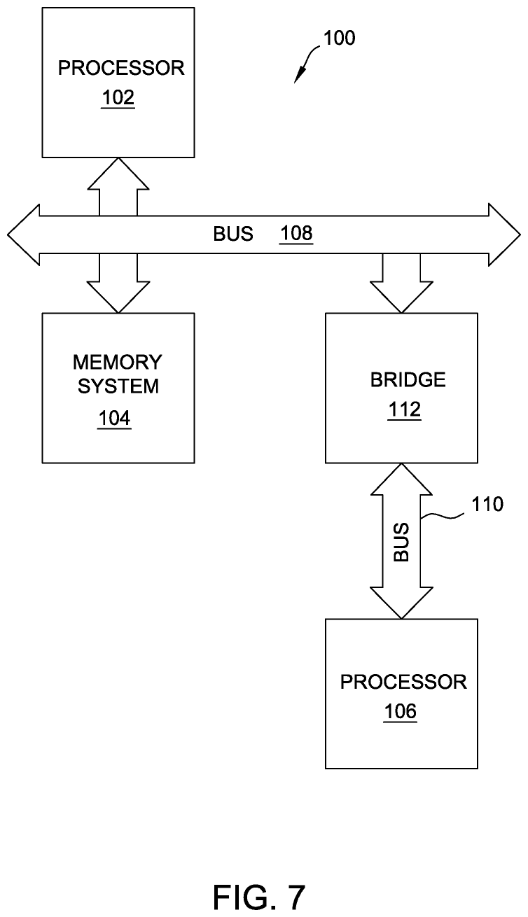

FIG. 7 is an example of a simplified functional block diagram of a computer system 100. The functional descriptions of the present invention can be implemented in hardware, software or some combination thereof.

As shown in FIG. 7, the computer system 100 includes a processor 102, a memory system 104 and one or more input/output (I/O) devices 106 in communication by a communication ‘fabric’. The communication fabric can be implemented in a variety of ways and may include one or more computer buses 108, 110 and/or bridge and/or router devices 112 as shown in FIG. 7. The I/O devices 106 can include network adapters and/or mass storage devices from which the computer system 100 can send and receive data for generating and transmitting advertisements with endorsements and associated news. The computer system 100 may be in communication with the Internet via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. An automated feeding system for plants, comprising:
a plant housing coupled to a fill line and an air line;
a reservoir configured to hold feed solution;
a first pump coupled to the fill line;
a second pump coupled to the air line;
one or more air stones located within the plant housing and coupled to the air line; and
a controller communicatively coupled to the first pump and the second pump.

2. The automated feeding system of claim 1, wherein the first pump is located in the reservoir.

3. The automated feeding system of claim 2, wherein the first pump is configured to pump feed solution contained in the reservoir into the fill line, and the fill line is configured to transport the feed solution to the plant housing.

4. The automated feeding system of claim 1, wherein the second pump is configured to pump air into the air line, and the air line is configured to add air to the plant housing via the one or more air stones.

5. The automated feeding system of claim 4, wherein the added air increases a volumetric pressure within the plant housing.

6. The automated feeding system of claim 5, further comprising housing caps, wherein the added air creates a seal around a base of a plant contained in the plant housing and the plant housing.

7. The automated feeding system of claim 1, further comprising a drain line coupled to the plant housing and the reservoir.

8. The automated feeding system of claim 7, wherein the drain line is configured to circulate excess feed solution from the plant housing to the reservoir when the first pump is active.

9. The automated feeding system of claim 7, wherein the drain line is configured to drain feed solution from the plant housing completely when the first pump is inactive.

10. The automated feeding system of claim 7, wherein the second pump is configured to pump air into the air line, and the air line is configured to feed the one or more air stones to diffuse air into the feed solution while it is recirculating.

11. The automated feeding system of claim 1, wherein the controller is configured to cause the first pump and second pump to start and stop.

12. The automated feeding system of claim 1, wherein the controller is configured to start the first pump and the second pump after a first condition has been met and stop the first pump and the second pump after a second condition has been met.

13. The automated feeding system of claim 12, wherein the first condition is a first predetermined period of time elapsing and the second condition is a second predetermined period of time elapsing.

14. The automated feeding system of claim 13, wherein the first predetermined period of time and the second predetermined period of time mimic indulgence and fasting.

15. The automated feeding system of claim 1, wherein the fill line is symmetrical in design.

16. The automated feeding system of claim 1, further comprising one or more other plant housings coupled to the fill line and the air line.

17. The automated feeding system of claim 1, wherein the controller communicatively coupled to the first pump and the second pump via a wired connection.

18. The automated feeding system of claim 1, wherein the controller is communicatively coupled to the first pump and the second pump via a wireless connection.

19. The automated feeding system of claim 1, wherein the controller is communicatively coupled to one or more sensors located within the plant housing.

20. The automated feeding system of claim 19, wherein the one or more sensors indicate a condition of plants located within the plant housing.
